(19) United States
(12) Patent Application Publication
(10) Pub. No.: US 2023/0398559 A1
(43) Pub. Date: Dec. 14, 2023

(54) PARALLELIZED DROPLET GENERATING APPARATUS

(71) Applicant: RESEARCH & BUSINESS FOUNDATION SUNGKYUNKWAN UNIVERSITY, Suwon-si (KR)

(72) Inventors: Jinkee LEE, Suwon-si (KR); Seonghun SHIN, Suwon-si (KR); Seongsu CHO, Suwon-si (KR)

(73) Assignee: RESEARCH & BUSINESS FOUNDATION SUNGKYUNKWAN UNIVERSITY, Suwon-si (KR)

(21) Appl. No.: 18/331,332

(22) Filed: Jun. 8, 2023

(30) Foreign Application Priority Data
Jun. 9, 2022 (KR) 10-2022-0070350

(51) Int. Cl. B05B 7/04

(52) U.S. Cl. CPC B05B 7/0408

(57) ABSTRACT

A parallelized droplet generating apparatus may include: a first inlet configured to introduce a continuous-phase fluid; a second inlet configured to introduce a dispersed-phase fluid; a first splitter configured to split the continuous-phase fluid introduced through the first inlet; a second splitter configured to split the dispersed-phase fluid introduced through the second inlet; and a droplet generator configured to combine the continuous-phase fluid split by the first splitter and the dispersed-phase fluid split by the second splitter to generate droplets.

### CROSS-REFERENCE TO RELATED APPLICATION

This application claims the benefit of Korean Patent Application No. 10-2022-0070350, filed on Jun. 9, 2022 in the Korean Intellectual Property Office, the entire disclosures of which are incorporated herein by reference.

### BACKGROUND

### 1. Field of the Invention

The present disclosure relates to a parallelized droplet generating apparatus, and more particularly, to a parallelized droplet generating apparatus capable of uniformly and promptly generating a plurality of droplets at once using a single device.

### 2. Discussion of Related Art

Generally, droplet-based microfluidics is widely used in the fields of chemistry, biology, diagnosis, food, cosmetics, and the like. A droplet generating apparatus is an essential apparatus in droplet-based microfluidics research, and it is important to produce droplets having a shape suitable for a certain purpose with uniform quality.

However, the conventional glass capillary microfluidic device or polydimethylsiloxane (PDMS)-based droplet generating device has problems that a high level of skill is required due to a complex device manufacturing process, and a production speed is slow. Also, although there have been attempts to parallelize droplet generators based on PDMS and polymethyl methacrylate (PMMA) materials in order to increase the production speed, there are problems that a level of difficulty of manufacturing the device is high, only droplets of limited shapes can be produced, and the volume of the device becomes too large.

The related art of the present disclosure is disclosed in Korean Patent Registration No. 10-1833610 (date of registration: Feb. 22, 2018, title of disclosure: Device for manufacturing fine particles).

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure is directed to providing a parallelized droplet generating apparatus capable of uniformly and promptly generating a plurality of droplets at once using a single device.

A parallelized droplet generating apparatus according to the present disclosure includes: a first inlet configured to introduce a continuous-phase fluid; a second inlet configured to introduce a dispersed-phase fluid; a first splitter configured to split the continuous-phase fluid introduced through the first inlet; a second splitter configured to split the dispersed-phase fluid introduced through the second inlet; and a droplet generator configured to combine the continuous-phase fluid split by the first splitter and the dispersed-phase fluid split by the second splitter to generate droplets.

The first splitter may include: a first splitting body configured to receive the continuous-phase fluid from the first inlet; a plurality of first splitting channels disposed to be spaced apart from the first splitting body; and a first flow rate controller configured to control a flow rate of the continuous-phase fluid introduced from the first splitting body into the first splitting channels.

The first flow rate controller may introduce the continuous-phase fluid with the same flow rate into each of the first splitting channels.

The first flow rate controller may include a plurality of first flow rate controlling channels provided between the first splitting body and the first splitting channels and having different cross-sectional areas from one another.

Each of the first flow rate controlling channels may be disposed coaxially with one of the first splitting channels.

A size of the cross-sectional areas of the plurality of first flow rate controlling channels may increase in proportion to a distance from the first inlet.

The second splitter may include: a second splitting body configured to receive the dispersed-phase fluid from the second inlet; a plurality of second splitting channels disposed to be spaced apart from the second splitting body; and a second flow rate controller configured to control a flow rate of the dispersed-phase fluid introduced from the second splitting body into the second splitting channels.

The second flow rate controller may include a plurality of second flow rate controlling channels provided between the second splitting body and the second splitting channels and having different cross-sectional areas from one another.

A size of the cross-sectional areas of the plurality of second flow rate controlling channels may increase in proportion to a distance from the second inlet.

The droplet generator may include: a first droplet generating channel configured to be connected to the first splitter and allow the continuous-phase fluid to flow in a direction parallel to a first direction; a spraying nozzle configured to be connected to the second splitter and spray the dispersed-phase fluid in a second direction, crossing the first direction, toward an inside of the first droplet generating channel; and a second droplet generating channel disposed to be spaced apart from the spraying nozzle and connected to the first droplet generating channel.

The spraying nozzle may be provided as a plurality of spraying nozzles, each of which is individually connected to one of the second splitting channels, and the second droplet generating channel may be provided as a plurality of second droplet generating channels, each of which is disposed to individually face one of the spraying nozzles.

The second droplet generating channel may extend in a direction parallel to the second direction.

The spraying nozzle may include: a nozzle body disposed between the second splitting channels and the second droplet generating channel; and a spraying channel configured to be connected to the second splitting channels and guide a flow of the dispersed-phase fluid inside the nozzle body.

The nozzle body may be formed to have a width that progressively decreases toward an end.

The second inlet may include: a second-first inlet configured to introduce a first dispersed-phase fluid; and a second-second inlet configured to introduce a second dispersed-phase fluid, and the second splitter may be provided as a pair of second splitters and connected to each of the second-first inlet and the second-second inlet.

The spraying channel may include: a first spraying channel configured to be connected to the second splitting channel provided in any one of the pair of second splitters and guide a flow of the first dispersed-phase fluid; and a second spraying channel configured to be connected to the second splitting channel provided in the other of the pair of second splitters and guide a flow of the second dispersed-phase fluid.

The first spraying channel and the second spraying channel may induce the first dispersed-phase fluid and the second dispersed-phase fluid to be sprayed symmetrically toward the inside of the first droplet generating channel.

The first spraying channel and the second spraying channel may induce the first dispersed-phase fluid and the second dispersed-phase fluid to be sprayed concentrically toward the inside of the first droplet generating channel.

The first spraying channel may include: a plurality of extension channels split from the second splitting channels; and a combining channel configured to be connected to the extension channels and combine the first dispersed-phase fluid flowing along the extension channels, and the second spraying channel may communicate with the combining channel and may be disposed so that a central axis is positioned coaxially with a central axis of the combining channel.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view schematically illustrating a configuration of a parallelized droplet generating apparatus according to a first embodiment of the present disclosure;

FIG. 2 is a perspective view illustrating the configuration of the parallelized droplet generating apparatus according to the first embodiment of the present disclosure from a different perspective from FIG. 1;

FIG. 3 is a plan view schematically illustrating the configuration of the parallelized droplet generating apparatus according to the first embodiment of the present disclosure;

FIG. 4 is a lateral view schematically illustrating the configuration of the parallelized droplet generating apparatus according to the first embodiment of the present disclosure;

FIG. 5 is an exploded perspective view schematically illustrating the configuration of the parallelized droplet generating apparatus according to the first embodiment of the present disclosure;

FIG. 6 is a perspective view schematically illustrating configurations of a first splitter and a second splitter according to the first embodiment of the present disclosure;

FIG. 7 is a cross-sectional view schematically illustrating the configurations of the first splitter and the second splitter according to the first embodiment of the present disclosure;

FIG. 8 is an enlarged view schematically illustrating a configuration of a droplet generator according to the first embodiment of the present disclosure;

FIG. 9 is a cross-sectional view schematically illustrating the configuration of the droplet generator according to the first embodiment of the present disclosure;

FIGS. 10 and 11 are views schematically illustrating an operation process of the parallelized droplet generating apparatus according to the first embodiment of the present disclosure;

FIG. 12 is a perspective view schematically illustrating a configuration of a parallelized droplet generating apparatus according to a second embodiment of the present disclosure;

FIG. 13 is a plan view schematically illustrating the configuration of the parallelized droplet generating apparatus according to the second embodiment of the present disclosure;

FIG. 14 is an enlarged view schematically illustrating a configuration of a spraying channel according to the second embodiment of the present disclosure; and

FIG. 15 is a view schematically illustrating a droplet generation process by the spraying channel according to the second embodiment of the present disclosure.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments of a parallelized droplet generating apparatus according to the present disclosure will be described with reference to the accompanying drawings.

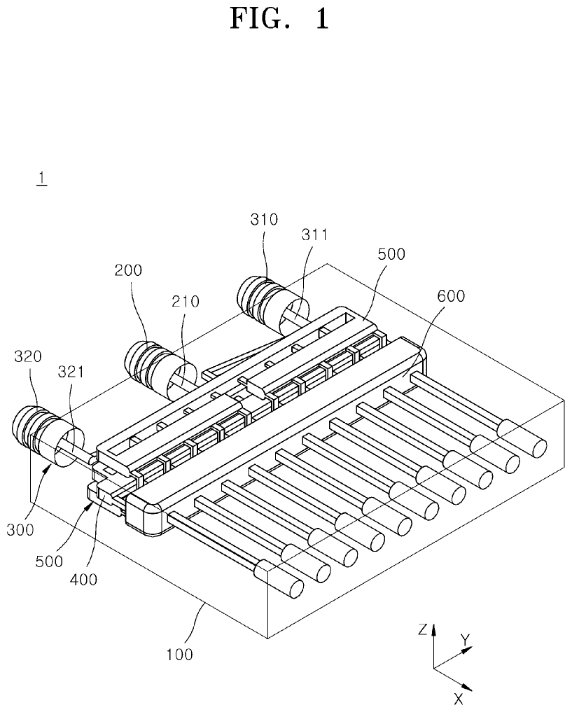

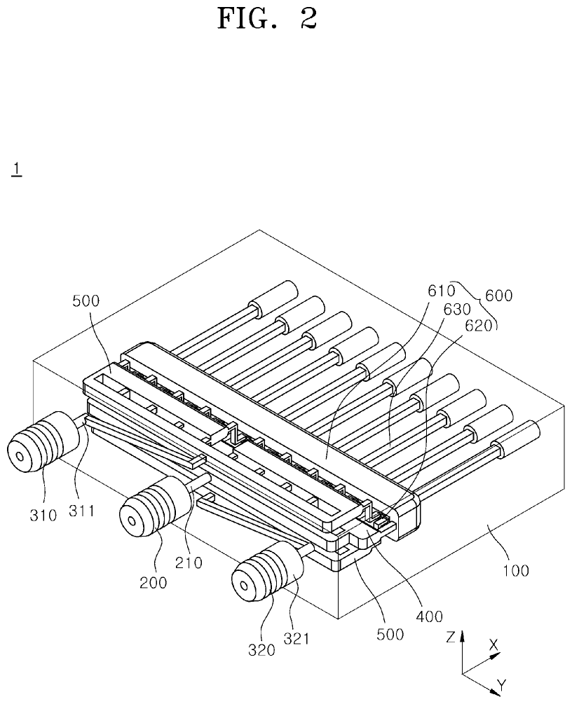

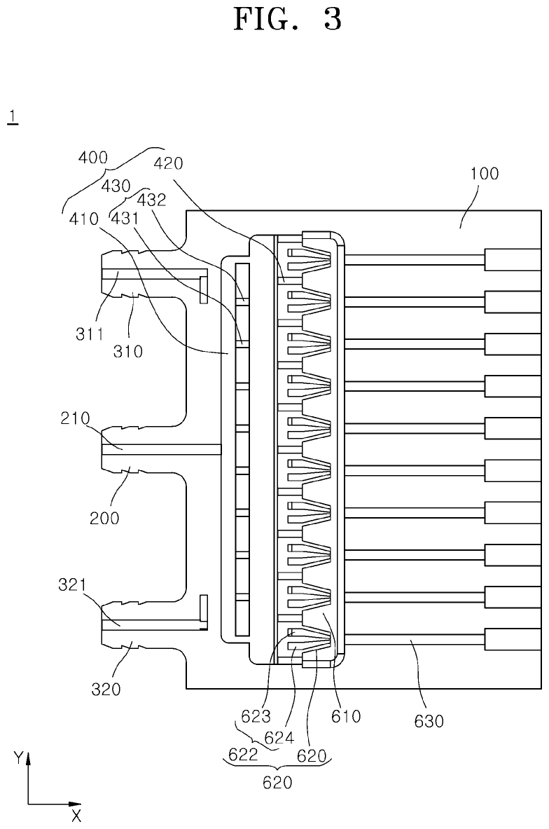

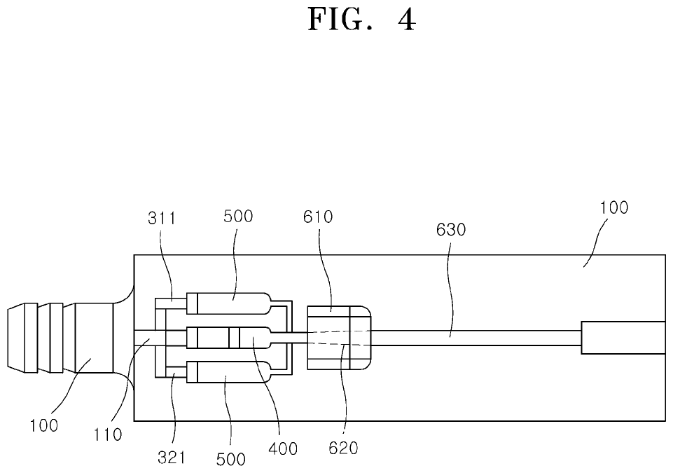

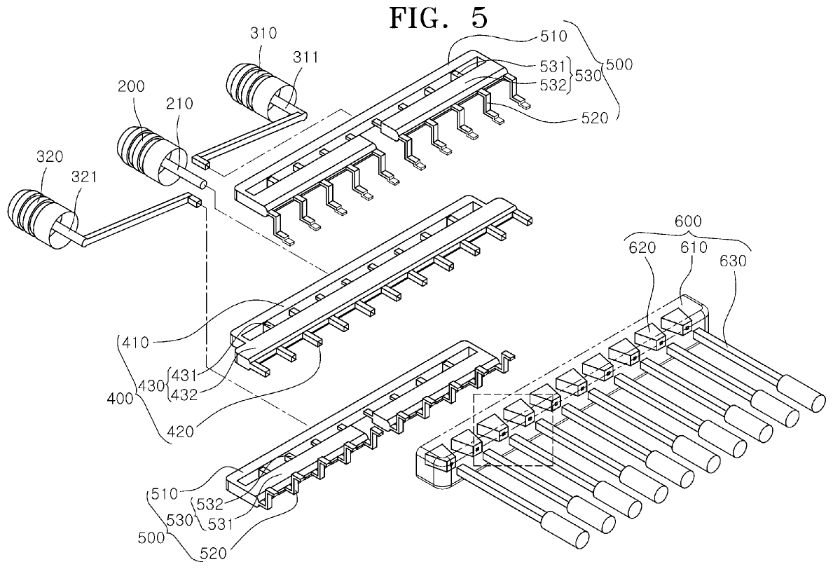

FIG. 1 is a perspective view schematically illustrating a configuration of a parallelized droplet generating apparatus according to a first embodiment of the present disclosure, FIG. 2 is a perspective view illustrating the configuration of the parallelized droplet generating apparatus according to the first embodiment of the present disclosure from a different perspective from FIG. 1, FIG. 3 is a plan view schematically illustrating the configuration of the parallelized droplet generating apparatus according to the first embodiment of the present disclosure, FIG. 4 is a lateral view schematically illustrating the configuration of the parallelized droplet generating apparatus according to the first embodiment of the present disclosure, and FIG. 5 is an exploded perspective view schematically illustrating the configuration of the parallelized droplet generating apparatus according to the first embodiment of the present disclosure.

Referring to FIGS. 1 to 5, a parallelized droplet generating apparatus 1 according to the present embodiment includes a main body 100, a first inlet 200, a second inlet 300, a first splitter 400, a second splitter 500, and a droplet generator 600.

The main body 100 forms an exterior of the parallelized droplet generating apparatus 1 and supports all of the first inlet 200, the second inlet 300, the first splitter 400, the second splitter 500, and the droplet generator 600. The main body 100 according to the present embodiment may be formed to have the shape of a hollow box.

The first inlet 200 is provided in the main body 100, and a continuous-phase fluid is introduced through the first inlet 200. That is, the first inlet 200 serves as a configuration for introducing a continuous-phase fluid supplied from outside the main body 100 into the main body 100. Here, for example, the continuous-phase fluid may be a mineral oil.

The first inlet 200 according to the present embodiment may be formed to have the shape of a column that protrudes from one side of the main body 100.

A first inlet channel 210 configured to guide a flow of the continuous-phase fluid inside the first inlet 200 is formed in the first inlet 200. The first inlet channel 210 according to the present embodiment may be formed to have a tubular shape and disposed inside the first inlet 200. The first inlet channel 210 is disposed so that the longitudinal direction thereof is parallel to the longitudinal direction of the first inlet 200. The first inlet channel 210 has one end passing through an end of the first inlet 200 to communicate with an outer space of the main body 100. The one end of the first inlet channel 210 may be connected to various types of fluid supply means, such as a tube, and receive the continuous-phase fluid. The first inlet channel 210 has the other end extending toward an inner space of the main body 100 to be connected to the first splitter 400 which will be described below.

The second inlet 300 is provided in the main body 100, and a dispersed-phase fluid is introduced through the second inlet 300. That is, the second inlet 300 serves as a configuration for introducing a dispersed-phase fluid supplied from outside the main body 100 into the main body 100. Here, the dispersed-phase fluid is a fluid not mixed with the continuous-phase fluid and may include a first dispersed-phase fluid, an example of which is a hydrophilic photopolymerizable polymer, and a second dispersed-phase fluid, an example of which is a hydrophobic photopolymerizable polymer.

The second inlet 300 according to the present embodiment includes a second-first inlet 310 configured to introduce the first dispersed-phase fluid and a second-second inlet 320 configured to introduce the second dispersed-phase fluid.

The second-first inlet 310 and the second-second inlet 320 according to the present embodiment may be formed to have the shape of a column that protrudes from one side of the main body 100. The second-first inlet 310 and the second-second inlet 320 may be symmetrically disposed at both sides of the first inlet 200. For example, as illustrated in FIG. 1, the second-first inlet 310 and the second-second inlet 320 may be disposed to be spaced a predetermined distance apart from each other in the Y-axis direction with the first inlet 200 disposed therebetween. The second-first inlet 310 and the second-second inlet 320 may be disposed so that the longitudinal directions thereof are parallel to the longitudinal direction of the first inlet 200.

A second-first inlet channel 311 configured to guide a flow of the first dispersed-phase fluid inside the second-first inlet 310 and a second-second inlet channel 321 configured to guide a flow of the second dispersed-phase fluid inside the second-second inlet 320 are formed in the second-first inlet 310 and the second-second inlet 320, respectively. The second-first inlet channel 311 and the second-second inlet channel 321 according to the first embodiment of the present disclosure may be formed to have a tubular shape and disposed inside the second-first inlet 310 and the second-second inlet 320, respectively. The second-first inlet channel 311 is disposed so that the longitudinal direction thereof is parallel to the longitudinal direction of the second-first inlet 310, and the second-second inlet channel 321 is disposed so that the longitudinal direction thereof is parallel to the longitudinal direction of the second-second inlet 320. The second-first inlet channel 311 has one end passing through an end of the second-first inlet 310 to communicate with the outer space of the main body 100, and the second-second inlet channel 321 has one end passing through an end of the second-second inlet 320 to communicate with the outer space of the main body 100. The one end of the second-first inlet channel 311 and the one end of the second-second inlet channel 321 may be connected to various types of fluid supply means, such as a tube, and receive the first dispersed-phase fluid and the second dispersed-phase fluid. The second-first inlet channel 311 and the second-second inlet channel 321 each have the other end extending toward the inner space of the main body 100 so that each of the other end of the second-first inlet channel 311 and the other end of the second-second inlet channel 321 is connected to one of a pair of second splitters 500 which will be described below.

The first splitter 400 is connected to the first inlet 200 and splits the continuous-phase fluid introduced through the first inlet 200.

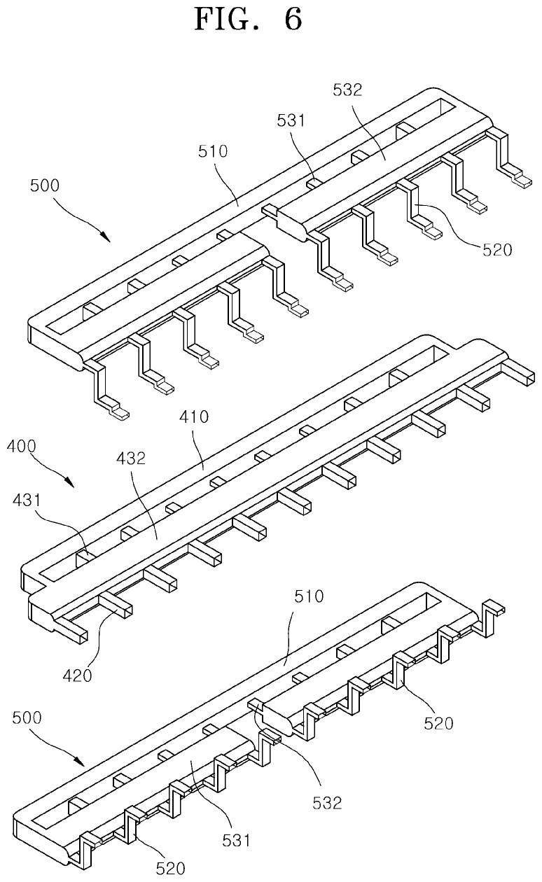

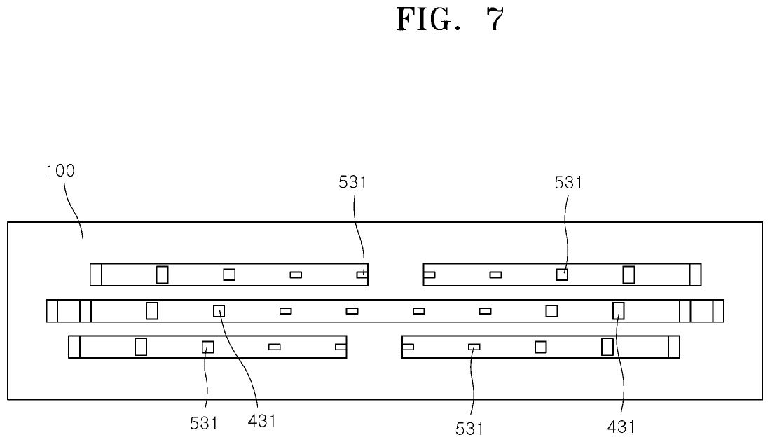

FIG. 6 is a perspective view schematically illustrating configurations of a first splitter and a second splitter according to the first embodiment of the present disclosure, and FIG. 7 is a cross-sectional view schematically illustrating the configurations of the first splitter and the second splitter according to the first embodiment of the present disclosure.

Referring to FIGS. 1 to 7, the first splitter 400 according to the present embodiment includes a first splitting body 410, a first splitting channel 420, and a first flow rate controller 430.

The first splitting body 410 is connected to the first inlet 200 and receives the continuous-phase fluid from the first inlet 200. The first splitting body 410 according to the present embodiment may be formed to have the shape of a hollow box and may be disposed inside the main body 100. The first splitting body 410 has one side connected to the other end of the first inlet channel 210 to receive therein the continuous-phase fluid flowing along the first inlet channel 210.

The first splitting channel 420 splits the continuous-phase fluid introduced into the first splitting body 410 into a plurality of paths to deliver the continuous-phase fluid to the droplet generator 600 which will be described below. The first splitting channel 420 according to the present embodiment may be formed to have the shape of a tube that extends in the X-axis direction. The first splitting channel 420 is disposed to be spaced a predetermined distance apart from the first splitting body 410 in the X-axis direction. The first splitting channel 420 is formed as a plurality of first splitting channels 420. The plurality of first splitting channels 420 are disposed to be spaced apart from each other in the Y-axis direction. The number of first splitting channels 420 is not limited to that illustrated in FIG. 5 and may be changed to various other numbers according to the size or the like of the first splitting body 410.

The first flow rate controller 430 controls a flow rate of the continuous-phase fluid introduced from the first splitting body 410 into the first splitting channels 420. More specifically, the first flow rate controller 430 serves as a configuration that introduces the continuous-phase fluid, introduced from the first splitting body 410 into the first splitting channels 420, with the same flow rate into each of the first splitting channels 420.

The first flow rate controller 430 according to the present embodiment may be configured to include a first flow rate controlling channel 431.

The first flow rate controlling channel 431 according to the present embodiment is formed to have the shape of a tube extending in the X-axis direction and is disposed between the first splitting body 410 and the first splitting channels 420. The first flow rate controlling channel 431 is formed as a plurality of first flow rate controlling channels 431. The plurality of first flow rate controlling channels 431 are disposed to be spaced apart from each other in the Y-axis direction. The number of the plurality of first flow rate controlling channels 431 may correspond to the number of first splitting channels 420, and each of the first flow rate controlling channels 431 may be disposed coaxially with one of the first splitting channels 420. The first flow rate controlling channel 431 has one end connected to the other side of the first splitting body 410, that is, a side opposite to the side connected to the first inlet channel 210, and the other end connected to the first splitting channel 420. In this case, the other ends of the plurality of first flow rate controlling channels 431 may be indirectly connected to the first splitting channels 420 via a first delivering channel 432 or may be directly connected to the first splitting channels 420.

The plurality of first flow rate controlling channels 431 are formed to have different cross-sectional areas from one another. In this case, the plurality of first flow rate controlling channels 431 may be formed so that a size of cross-sectional areas thereof increases in proportion to a distance from the first inlet 200. That is, the first flow rate controlling channels 431 reduce a flow area of the continuous-phase fluid introduced into the first splitting channel 420 positioned relatively close to the first inlet channel 210 and expand a flow area of the continuous-phase fluid introduced into the first splitting channel 420 positioned relatively far away from the first inlet channel 210, thereby inducing the continuous-phase fluid to be delivered with the same flow rate toward each of the first splitting channels 420. For example, as illustrated in FIG. 7, since the first inlet channel 210 is connected to a substantially central portion of the first splitting body 410, the plurality of first flow rate controlling channels 431 are formed so that the size of the cross-sectional areas thereof gradually increases toward an end of the first splitting body 410. Accordingly, the size of the first flow rate controlling channel 431 can be reduced as compared to typical split type structures for delivering a fluid with the same flow rate to a plurality of flow paths, the first flow rate controlling channel 431 can be easily manufactured, and a waste of fluid can be prevented.

The second splitter 500 is connected to the second inlet 300 and splits the dispersed-phase fluid introduced through the second inlet 300. The second splitter 500 may be formed as a pair of second splitters 500. Any one of the pair of second splitters 500 is connected to the second-first inlet 310 and splits the first dispersed-phase fluid introduced through the second-first inlet 310 to deliver the first dispersed-phase fluid to the droplet generator 600 which will be described below. The other of the pair of second splitters 500 is connected to the second-second inlet 320 and splits the second dispersed-phase fluid introduced through the second-second inlet 320 to deliver the second dispersed-phase fluid to the droplet generator 600 which will be described below. The pair of second splitters 500 may be symmetrically disposed at both sides of the first splitter 400. For example, as illustrated in FIG. 4, the pair of second splitters 500 may be disposed to be spaced apart from each other in the Z-axis direction with the first splitter 400 disposed therebetween.

The second splitter 500 according to the present embodiment includes a second splitting body 510, a second splitting channel 520, and a second flow rate controller 530.

The second splitting body 510 is connected to the second inlet 300 and receives the dispersed-phase fluid from the second inlet 300. The second splitting body 510 according to the present embodiment may be formed to have the shape of a hollow box and may be disposed inside the main body 100. The second splitting body 510 provided in any one of the pair of second splitters 500 has one side connected to the other end of the second-first inlet channel 311 to receive therein the first dispersed-phase fluid flowing along the second-first inlet channel 311. The second splitting body 510 provided in the other of the pair of second splitters 500 has one side connected to the other end of the second-second inlet channel 321 to receive therein the second dispersed-phase fluid flowing along the second-second inlet channel 321.

The second splitting channel 520 splits the dispersed-phase fluid introduced into the second splitting body 510 into a plurality of paths to deliver the dispersed-phase fluid to the droplet generator 600 which will be described below. The second splitting channel 520 according to the present embodiment may be formed to have the shape of a hollow tube. The second splitting channel 520 is disposed to be spaced a predetermined distance apart from the second splitting body 510 in the X-axis direction. The second splitting channel 520 is formed as a plurality of second splitting channels 520. The plurality of second splitting channels 520 are disposed to be spaced apart from each other in the Y-axis direction. The number of second splitting channels 520 is not limited to that illustrated in FIG. 5 and may be changed to various other numbers according to the size or the like of the second splitting body 510. The second splitting channel 520 provided in the second splitter 500 connected to the second-first inlet channel 311 among the pair of second splitters 500 may be formed to have a shape that is bent downward toward the first splitting channel 420. The second splitting channel 520 provided in the second splitter 500 connected to the second-second inlet channel 321 among the pair of second splitters 500 may be formed to have a shape that is bent upward toward the first splitting channel 420.

The second flow rate controller 530 controls a flow rate of the dispersed-phase fluid introduced from the second splitting body 510 into the second splitting channels 520. More specifically, the second flow rate controller 530 serves as a configuration that introduces the dispersed-phase fluid, introduced from the second splitting body 510 into the second splitting channels 520, with the same flow rate into each of the second splitting channels 520.

The second flow rate controller 530 according to the present embodiment may be configured to include a second flow rate controlling channel 531.

The second flow rate controlling channel 531 according to the present embodiment is formed to have the shape of a tube extending in the X-axis direction and is disposed between the second splitting body 510 and the second splitting channels 520. The second flow rate controlling channel 531 is formed as a plurality of second flow rate controlling channels 531. The plurality of second flow rate controlling channels 531 are disposed to be spaced apart from each other in the Y-axis direction. The number of the plurality of second flow rate controlling channels 531 may correspond to the number of second splitting channels 520, and each of the second flow rate controlling channels 531 may be disposed coaxially with one of the second splitting channels 520. The second flow rate controlling channel 531 has one end connected to the other side of the second splitting body 510, that is, a side opposite to the side connected to the second-first inlet channel 311 or second-second inlet channel 321, and the other end connected to the second splitting channel 520. In this case, the other ends of the plurality of second flow rate controlling channels 531 may be indirectly connected to the second splitting channels 520 via a second delivering channel 532 or may be directly connected to the second splitting channels 520.

The plurality of second flow rate controlling channels 531 are formed to have different cross-sectional areas from one another. In this case, the plurality of second flow rate controlling channels 531 may be formed so that a size of cross-sectional areas thereof increases in proportion to a distance from the second inlet 300. That is, the second flow rate controlling channels 531 reduce a flow area of the dispersed-phase fluid introduced into the second splitting channel 520 positioned relatively close to the second-first inlet channel 311 or second-second inlet channel 321 and expand a flow area of the dispersed-phase fluid introduced into the second splitting channel 520 positioned relatively far away from the second-first inlet channel 311 or second-second inlet channel 321, thereby inducing the dispersed-phase fluid to be delivered with the same flow rate toward each of the second splitting channels 520. For example, as illustrated in FIG. 7, as the second-first inlet channel 311 or second-second inlet channel 321 is connected to a substantially central portion of the second splitting body 510, the plurality of second flow rate controlling channels 531 are formed so that the size of the cross-sectional areas thereof gradually increases toward an end of the second splitting body 510. Accordingly, the size of the second flow rate controlling channel 531 can be reduced as compared to typical split type structures for delivering a fluid with the same flow rate to a plurality of flow paths, the second flow rate controlling channel 531 can be easily manufactured, and a waste of fluid can be prevented.

The droplet generator 600 combines the continuous-phase fluid split by the first splitter 400 and the dispersed-phase fluid split by the second splitter 500 to generate droplets.

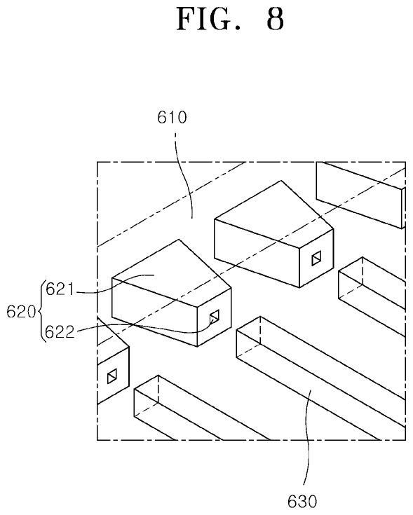

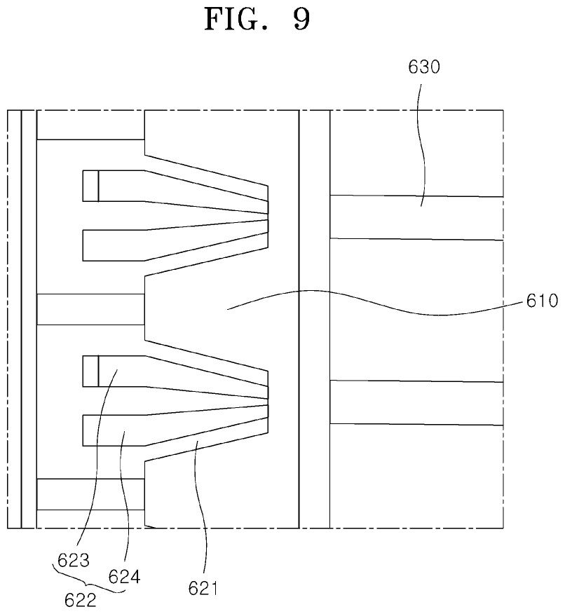

FIG. 8 is an enlarged view schematically illustrating a configuration of a droplet generator according to the first embodiment of the present disclosure, and FIG. 9 is a cross-sectional view schematically illustrating the configuration of the droplet generator according to the first embodiment of the present disclosure.

Referring to FIGS. 8 and 9, the droplet generator 600 according to the present embodiment includes a first droplet generating channel 610, a spraying nozzle 620, and a second droplet generating channel 630.

The first droplet generating channel 610 is connected to the first splitter 400 and allows the continuous-phase fluid to flow in a direction parallel to a first direction. Here, for example, the first direction may be a direction parallel to the Y-axis direction. The first droplet generating channel 610 according to the present embodiment may be formed to have the shape of a hollow box with one open side. The first droplet generating channel 610 is disposed so that the open side faces the ends of the plurality of first splitting channels 420, and the continuous-phase fluid discharged from the first splitting channels 420 is introduced into the first droplet generating channel 610. The first droplet generating channel 610 has a longitudinal direction extending in the direction parallel to the Y-axis direction and thus induces the continuous-phase fluid, introduced into the first droplet generating channel 610, to flow in the direction parallel to the Y-axis direction.

The spraying nozzle 620 is connected to the second splitter 500 and sprays the dispersed-phase fluid in a second direction, crossing the first direction, toward an inside of the first droplet generating channel 610. Here, for example, the second direction may be the X-axis direction perpendicular to the Y-axis direction. The spraying nozzle 620 is formed as a plurality of spraying nozzles 620. Each of the plurality of spraying nozzles 620 is individually connected to one of the second splitting channels 520. More specifically, the plurality of spraying nozzles 620 are individually connected at every pair of second splitting channels 520 provided in each of the pair of second splitters 500.

The spraying nozzle 620 according to the present embodiment includes a nozzle body 621 and a spraying channel 622.

The nozzle body 621 forms an exterior of the spraying nozzle 620 and is disposed between the second splitting channels 520 and the second droplet generating channel 630 which will be described below. The nozzle body 621 according to the present embodiment may be formed to have the shape of a box whose width progressively decreases toward an end. The nozzle body 621 is disposed so that an end of a wide-width side faces the second splitting channels 520, and an end of a narrow-width side faces the second droplet generating channel 630 which will be described below. Accordingly, the nozzle body 621 may induce a dispersed-phase fluid, sprayed into the first droplet generating channel 610 through the spraying channel 622 which will be described below, to be smoothly introduced into the second droplet generating channel 630.

The spraying channel 622 is connected to the second splitting channels 520, guides a flow of the dispersed-phase fluid inside the nozzle body 621, and sprays the dispersed-phase fluid in the second direction toward the first droplet generating channel 610.

The spraying channel 622 according to the present embodiment includes a first spraying channel 623 and a second spraying channel 624.

The first spraying channel 623 is connected to the second splitting channel 520 provided in any one of the pair of second splitters 500 and guides a flow of the first dispersed-phase fluid inside the nozzle body 621. The first spraying channel 623 according to the present embodiment may be formed to have the shape of a tube formed to pass through the nozzle body 621. One end of the first spraying channel 623 passes through the end of the wide-width side of the nozzle body 621 and is connected to the second splitting channel 520 provided in the second splitter 500 connected to the second-first inlet channel 311. The other end of the first spraying channel 623 passes through the end of the narrow-width side of the nozzle body 621 and communicates with the first droplet generating channel 610. The other end of the first spraying channel 623 may be disposed parallel to the second direction, that is, the X-axis direction.

The second spraying channel 624 is connected to the second splitting channel 520 provided in the other of the pair of second splitters 500 and guides a flow of the second dispersed-phase fluid inside the nozzle body 621. The second spraying channel 624 according to the present embodiment may be formed to have the shape of a tube formed to pass through the nozzle body 621. One end of the second spraying channel 624 passes through the end of the wide-width side of the nozzle body 621 and is connected to the second splitting channel 520 provided in the second splitter 500 connected to the second-second inlet channel 321. The other end of the second spraying channel 624 passes through the end of the narrow-width side of the nozzle body 621 and communicates with the first droplet generating channel 610. The other end of the second spraying channel 624 may be disposed parallel to the second direction, that is, the X-axis direction.

The first spraying channel 623 and the second spraying channel 624 are symmetrically disposed with respect to the central axis of the nozzle body 621. Since the nozzle body 621 has a substantially trapezoidal cross-sectional shape, the first spraying channel 623 and the second spraying channel 624 may be disposed in a form in which the other ends thereof come together toward the end of the narrow-width side of the nozzle body 621. The first spraying channel 623 and the second spraying channel 624 induce the first dispersed-phase fluid and the second dispersed-phase fluid to be sprayed symmetrically in the second direction toward the inside of the first droplet generating channel 610. Accordingly, the first spraying channel 623 and the second spraying channel 624 may induce Janus droplets to be generated in the second droplet generating channel 630 which will be described below.

The second droplet generating channel 630 is disposed to be spaced apart from the spraying nozzle 620 and is connected to the first droplet generating channel 610. The second droplet generating channel 630 allows the continuous-phase fluid and the dispersed-phase fluid cross-flowing in the first direction and second direction inside the first droplet generating channel 610 to be introduced into the second droplet generating channel 630 to induce generation of droplets and guides a flow of the generated droplets. The second droplet generating channel 630 according to the present embodiment may be formed to have the shape of a tube that extends in a direction in which the dispersed-phase fluid is sprayed by the spraying nozzle 620, that is, a direction parallel to the second direction. The second droplet generating channel 630 has one end passing through the first droplet generating channel 610 to communicate with an inner space of the first droplet generating channel 610. The other end of the second droplet generating channel 630 is disposed to be spaced a predetermined distance apart from and face the end of the narrow-width side of the spraying nozzle 620. The second droplet generating channel 630 is formed as a plurality of second droplet generating channels 630. Each of the plurality of second droplet generating channels 630 is disposed to individually face one of the spraying nozzles 620.

Hereinafter, an operation process of the parallelized droplet generating apparatus 1 according to the first embodiment of the present disclosure will be described.

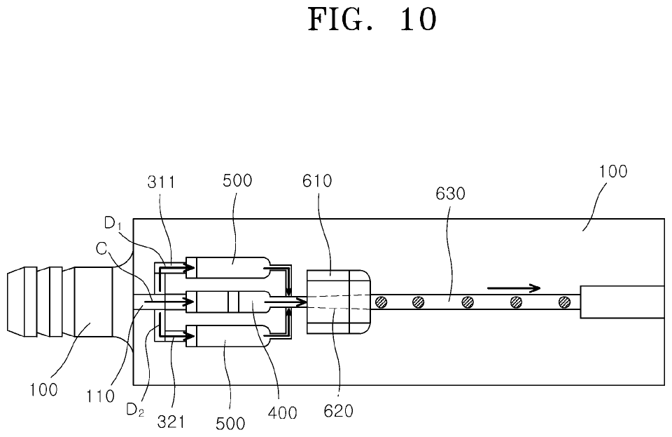

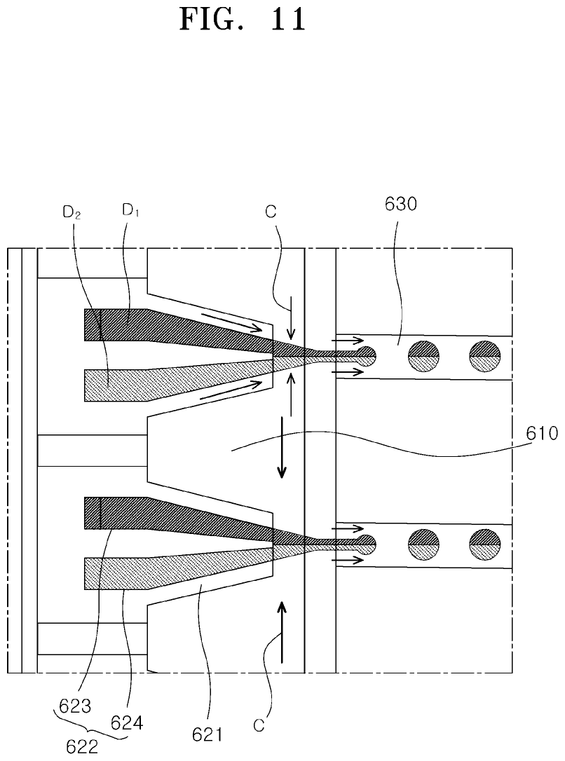

FIGS. 10 and 11 are views schematically illustrating an operation process of the parallelized droplet generating apparatus according to the first embodiment of the present disclosure.

Referring to FIGS. 1 to 11, a continuous-phase fluid C introduced into the first inlet 200 through the first inlet channel 210 is delivered to the first splitting body 410.

The continuous-phase fluid C introduced into the first splitting body 410 through the first inlet channel 210 is supplied with the same flow rate to each of the first splitting channels 420 by the first flow rate controller 430.

More specifically, a portion of the continuous-phase fluid C introduced into a central portion of the first splitting body 410 through the first inlet channel 210 flows toward an end of the first splitting body 410.

In this process, due to friction with the first splitting body 410, the continuous-phase fluid C introduced into the first splitting channel 420 positioned relatively far away from the first inlet channel 210 has a lower pressure than the continuous-phase fluid C introduced into the first splitting channel 420 positioned relatively close to the first inlet channel 210.

In this case, since the plurality of first flow rate controlling channels 431 are formed so that the size of the cross-sectional areas thereof increases in proportion to the distance from the first inlet 200, the continuous-phase fluid C having a higher pressure that is positioned at the central portion of the first splitting body 410 is introduced into the first splitting channel 420 through a relatively narrow area, and the continuous-phase fluid C having a lower pressure that is positioned at an end of the first splitting body 410 is introduced into the first splitting channel 420 through a relatively wide area.

Accordingly, each of the first splitting channels 420 may always receive the continuous-phase fluid C with the same flow rate regardless of the distance from the first inlet channel 210.

The continuous-phase fluid C is split into a plurality of paths by the plurality of first splitting channels 420 and is discharged to the first droplet generating channel 610.

The continuous-phase fluid C discharged to the first droplet generating channel 610 flows in a direction parallel to the first direction inside the first droplet generating channel 610. In this case, the continuous-phase fluids C discharged from the neighboring first splitting channels 420 may flow in directions opposite to each other while being parallel to the first direction inside the first droplet generating channel 610.

Meanwhile, a first dispersed-phase fluid D1 introduced into the second-first inlet 310 through the second-first inlet channel 311 is delivered to the second splitting body 510.

The first dispersed-phase fluid D1 introduced into the second splitting body 510 through the second-first inlet channel 311 is supplied with the same flow rate to each of the second splitting channels 520 by the second flow rate controller 530.

More specifically, a portion of the first dispersed-phase fluid D1 introduced into a central portion of the second splitting body 510 through the second-first inlet channel 311 flows toward an end of the second splitting body 510.

In this process, due to friction with the second splitting body 510, the first dispersed-phase fluid D1 introduced into the second splitting channel 520 positioned relatively far away from the second-first inlet channel 311 has a lower pressure than the first dispersed-phase fluid D1 introduced into the second splitting channel 520 positioned relatively close to the second-first inlet channel 311.

In this case, since the plurality of second flow rate controlling channels 531 are formed so that the size of the cross-sectional areas thereof increases in proportion to the distance from the second inlet 300, the first dispersed-phase fluid D1 having a higher pressure that is positioned at the central portion of the second splitting body 510 is introduced into the second splitting channel 520 through a relatively narrow area, and the first dispersed-phase fluid D1 having a lower pressure that is positioned at an end of the second splitting body 510 is introduced into the second splitting channel 520 through a relatively wide area.

Accordingly, each of the second splitting channels 520 may always receive the first dispersed-phase fluid D1 with the same flow rate regardless of the distance from the second-first inlet channel 311.

Likewise, a second dispersed-phase fluid D2 introduced into the second-second inlet 320 through the second-second inlet channel 321 is supplied with the same flow rate to each of the second splitting channels 520.

The first dispersed-phase fluid D1 and the second dispersed-phase fluid D2 are split into a plurality of paths by the plurality of second splitting channels 520 provided in each of the pair of second splitters 500 and are delivered to the spraying nozzles 620.

The first dispersed-phase fluid D1 flowing along the second splitting channel 520 provided in any one of the pair of second splitters 500 is introduced into the first spraying channel 623, and the second dispersed-phase fluid D2 flowing along the second splitting channel 520 provided in the other of the pair of second splitters 500 is introduced into the second spraying channel 624.

The first dispersed-phase fluid D1 and the second dispersed-phase fluid D2 flowing along the first spraying channel 623 and the second spraying channel 624 are sprayed symmetrically in the shape of a band in the second direction toward the inside of the first droplet generating channel 610.

The continuous-phase fluid C, the first dispersed-phase fluid D1, and the second dispersed-phase fluid D2 cross-flowing with each other inside the first droplet generating channel 610 are introduced into the second droplet generating channel 630.

Since the continuous-phase fluid C, the first dispersed-phase fluid D1, and the second dispersed-phase fluid D2 are formed of materials not mixed with each other, the continuous-phase fluid C, the first dispersed-phase fluid D1, and the second dispersed-phase fluid D2 form boundary surfaces inside the second droplet generating channel 630.

Since the first dispersed-phase fluid D1 and the second dispersed-phase fluid D2 continue to flow in the second direction in the longitudinal direction of the second droplet generating channel 630, due to a shear force generated by the continuous-phase fluid C, neck portions of the first dispersed-phase fluid D1 and the second dispersed-phase fluid D2 gradually narrow and completely break, and spherical Janus droplets are generated.

Such droplets are repeatedly generated due to continuous injection of the continuous-phase fluid C, the first dispersed-phase fluid D1, and the second dispersed-phase fluid D2 and flow in the longitudinal direction of the second droplet generating channel 630.

Hereinafter, a configuration of a parallelized droplet generating apparatus 1′ according to a second embodiment of the present disclosure will be described.

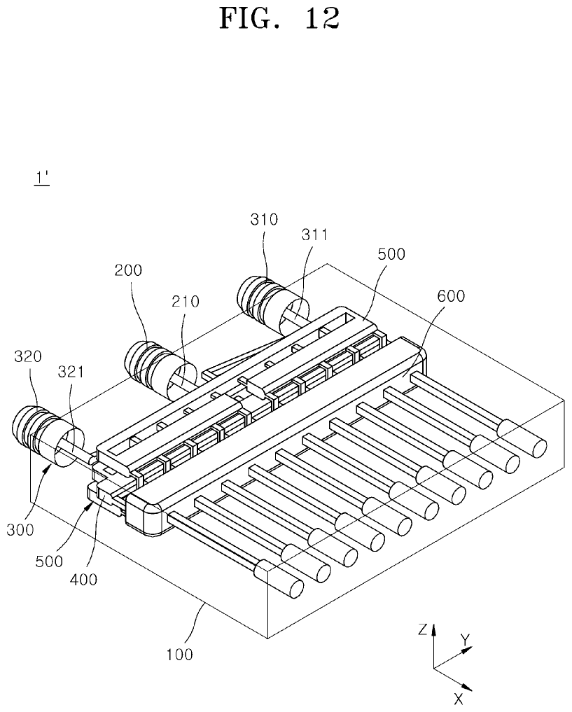

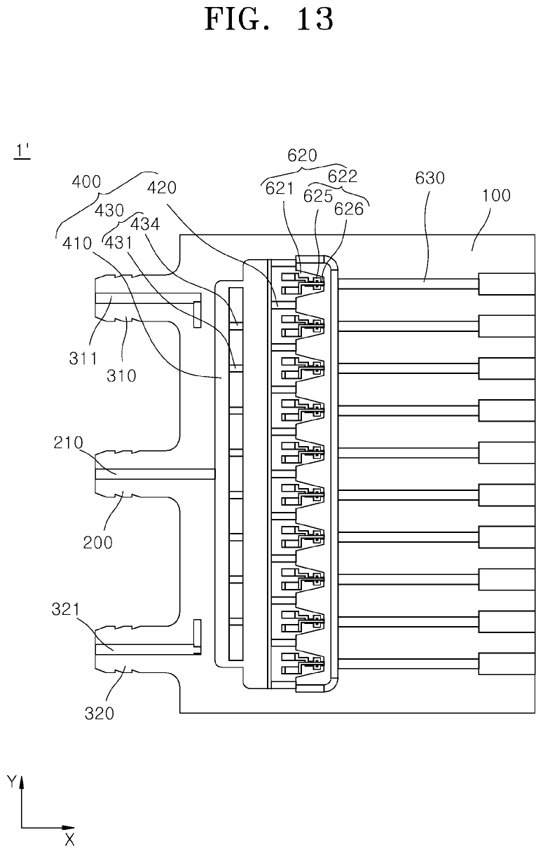

FIG. 12 is a perspective view schematically illustrating a configuration of a parallelized droplet generating apparatus according to a second embodiment of the present disclosure, and FIG. 13 is a plan view schematically illustrating the configuration of the parallelized droplet generating apparatus according to the second embodiment of the present disclosure.

Referring to FIGS. 12 and 13, the parallelized droplet generating apparatus 1′ according to the present embodiment includes a main body 100, a first inlet 200, a second inlet 300, a first splitter 400, a second splitter 500, and a droplet generator 600.

The parallelized droplet generating apparatus 1′ according to the second embodiment of the present disclosure is configured to differ from the parallelized droplet generating apparatus 1 according to the first embodiment of the present disclosure only in terms of a specific structure and function of a spraying channel 622. Therefore, in describing the configuration of the parallelized droplet generating apparatus 1′ according to the second embodiment of the present disclosure, only the spraying channel 622 differing from that of the parallelized droplet generating apparatus 1 according to the first embodiment of the present disclosure will be described. For the other configurations of the parallelized droplet generating apparatus 1′ according to the second embodiment of the present disclosure, the descriptions given above in relation to the parallelized droplet generating apparatus 1 according to the first embodiment of the present disclosure may apply without change.

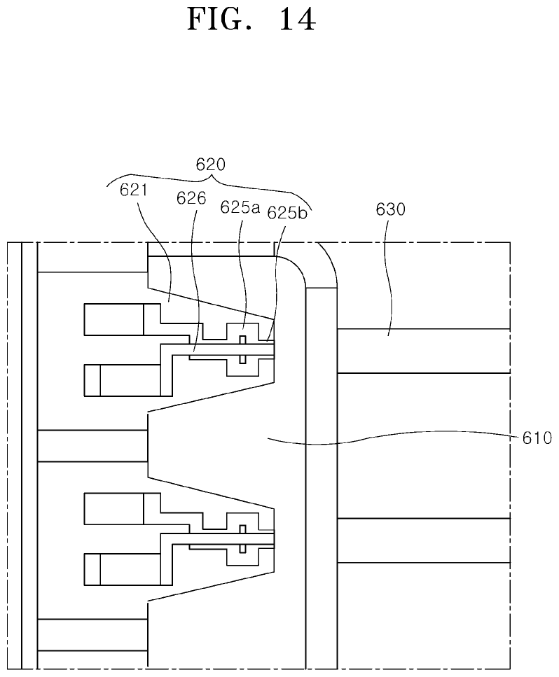

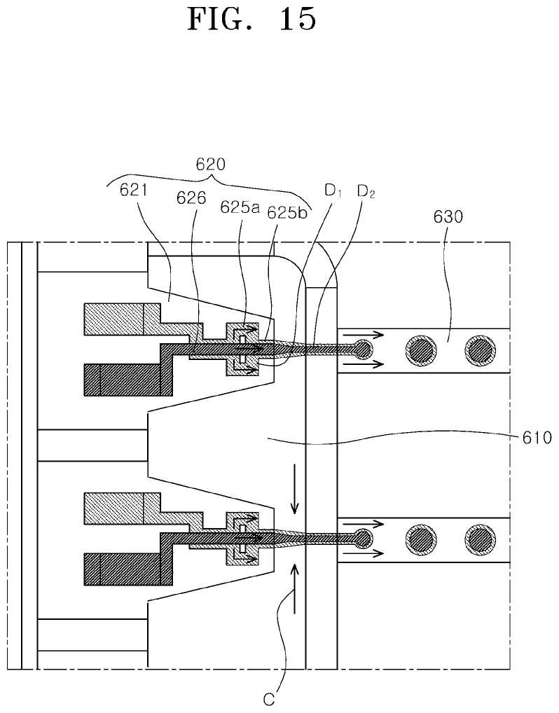

FIG. 14 is an enlarged view schematically illustrating a configuration of a spraying channel according to the second embodiment of the present disclosure, and FIG. 15 is a view schematically illustrating a droplet generation process by the spraying channel according to the second embodiment of the present disclosure.

Referring to FIGS. 14 and 15, the spraying channel 622 according to the present embodiment includes a first spraying channel 625 and a second spraying channel 626.

The first spraying channel 625 is connected to a second splitting channel 520 provided in any one of a pair of second splitters 500 and guides a flow of a first dispersed-phase fluid inside a nozzle body 621.

The first spraying channel 625 according to the present embodiment includes an extension channel 625a and a combining channel 625b.

The extension channel 625a is formed as a plurality of extension channels 625a and is split from the second splitting channel 520. The extension channel 625a according to the present embodiment may be formed to have the shape of a tube formed to pass through the nozzle body 621. One end of the extension channel 625a passes through an end of a wide-width side of the nozzle body 621 and is connected to the second splitting channel 520 provided in the second splitter 500 connected to a second-first inlet channel 311. The plurality of extension channels 625a may be formed to radially extend from a central axis of the second splitting channel 520.

The combining channel 625b is connected to the extension channels 625a and combines the first dispersed-phase fluid flowing along each extension channel 625a. The combining channel 625b according to the present embodiment may be formed to pass through the nozzle body 621 and formed to have the shape of a single tube whose one end is simultaneously connected to the other ends of the plurality of extension channels 625a. The other end of the combining channel 625b passes through an end of a narrow-width side of the nozzle body 621 and communicates with a first droplet generating channel 610. The other end of the combining channel 625b may be disposed parallel to the second direction, that is, the X-axis direction.

The second spraying channel 626 is connected to a second splitting channel 520 provided in the other of the pair of second splitters 500 and guides a flow of a second dispersed-phase fluid inside the nozzle body 621. The second spraying channel 626 according to the present embodiment may be formed to have the shape of a tube formed to pass through the nozzle body 621. One end of the second spraying channel 626 passes through the end of the wide-width side of the nozzle body 621 and is connected to the second splitting channel 520 provided in the second splitter 500 connected to the second-second inlet channel 321. The other end of the second spraying channel 626 communicates with the one end of the combining channel 625b and is disposed so that a central axis thereof is positioned coaxially with a central axis of the combining channel 625b. The other end of the second spraying channel 626 may be disposed parallel to the second direction, that is, the X-axis direction.

Referring to FIG. 15, with the above configuration, the first spraying channel 625 and the second spraying channel 626 may induce the first dispersed-phase fluid and the second dispersed-phase fluid to be sprayed concentrically toward the inside of the first droplet generating channel 610. Accordingly, the first spraying channel 625 and the second spraying channel 626 may induce double droplets to be generated in a second droplet generating channel 630.

A parallelized droplet generating apparatus according to the present disclosure can split a flow of a continuous-phase fluid introduced through a first inlet and a flow of a dispersed-phase fluid introduced through a second inlet into a plurality of paths and thus produce a plurality of droplets at once in a parallel manner with only one injection of the continuous-phase fluid and the dispersed-phase fluid. In this way, the efficiency and promptness of droplet generation can be improved.

Also, in the parallelized droplet generating apparatus according to the present disclosure, a plurality of first flow rate controlling channels and second flow rate controlling channels are formed so that a size of cross-sectional areas thereof increases in proportion to a distance from the first inlet or second inlet and thus induce the continuous-phase fluid to be delivered with the same flow rate toward each first splitting channel and each second splitting channel. Accordingly, the size of the first flow rate controlling channels and second flow rate controlling channels can be reduced as compared to typical split type structures, the first flow rate controlling channels and second flow rate controlling channels can be easily manufactured, and a waste of fluid can be prevented.

The present disclosure has been described above with reference to the embodiments illustrated in the drawings, but the description is merely illustrative, and those of ordinary skill in the art should understand that various modifications and other equivalent embodiments are possible therefrom. Therefore, the scope of technical protection of the present disclosure should be defined by the claims below.

What is claimed is:

1. A parallelized droplet generating apparatus comprising:
a first inlet configured to introduce a continuous-phase fluid;
a second inlet configured to introduce a dispersed-phase fluid;
a first splitter configured to split the continuous-phase fluid introduced through the first inlet;
a second splitter configured to split the dispersed-phase fluid introduced through the second inlet; and
a droplet generator configured to combine the continuous-phase fluid split by the first splitter and the dispersed-phase fluid split by the second splitter to generate droplets.

2. The parallelized droplet generating apparatus of claim 1, wherein the first splitter includes:
a first splitting body configured to receive the continuous-phase fluid from the first inlet;
a plurality of first splitting channels disposed to be spaced apart from the first splitting body; and
a first flow rate controller configured to control a flow rate of the continuous-phase fluid introduced from the first splitting body into the first splitting channels.

3. The parallelized droplet generating apparatus of claim 2, wherein the first flow rate controller introduces the continuous-phase fluid with the same flow rate into each of the first splitting channels.

4. The parallelized droplet generating apparatus of claim 2, wherein the first flow rate controller includes a plurality of first flow rate controlling channels provided between the first splitting body and the first splitting channels and having different cross-sectional areas from one another.

5. The parallelized droplet generating apparatus of claim 4, wherein each of the first flow rate controlling channels is disposed coaxially with one of the first splitting channels.

6. The parallelized droplet generating apparatus of claim 4, wherein a size of the cross-sectional areas of the plurality of first flow rate controlling channels increases in proportion to a distance from the first inlet.

7. The parallelized droplet generating apparatus of claim 1, wherein the second splitter includes:
a second splitting body configured to receive the dispersed-phase fluid from the second inlet;
a plurality of second splitting channels disposed to be spaced apart from the second splitting body; and
a second flow rate controller configured to control a flow rate of the dispersed-phase fluid introduced from the second splitting body into the second splitting channels.

8. The parallelized droplet generating apparatus of claim 7, wherein the second flow rate controller includes a plurality of second flow rate controlling channels provided between the second splitting body and the second splitting channels and having different cross-sectional areas from one another.

9. The parallelized droplet generating apparatus of claim 8, wherein a size of the cross-sectional areas of the plurality of second flow rate controlling channels increases in proportion to a distance from the second inlet.

10. The parallelized droplet generating apparatus of claim 7, wherein the droplet generator includes:
a first droplet generating channel configured to be connected to the first splitter and allow the continuous-phase fluid to flow in a direction parallel to a first direction;
a spraying nozzle configured to be connected to the second splitter and spray the dispersed-phase fluid in a second direction, crossing the first direction, toward an inside of the first droplet generating channel; and
a second droplet generating channel disposed to be spaced apart from the spraying nozzle and connected to the first droplet generating channel.

11. The parallelized droplet generating apparatus of claim 10, wherein the spraying nozzle is provided as a plurality of spraying nozzles, each of which is individually connected to one of the second splitting channels, and the second droplet generating channel is provided as a plurality of second droplet generating channels, each of which is disposed to individually face one of the spraying nozzles.

12. The parallelized droplet generating apparatus of claim 10, wherein the second droplet generating channel extends in a direction parallel to the second direction.

13. The parallelized droplet generating apparatus of claim 10, wherein the spraying nozzle includes:
a nozzle body disposed between the second splitting channels and the second droplet generating channel; and
a spraying channel configured to be connected to the second splitting channels and guide a flow of the dispersed-phase fluid inside the nozzle body.

14. The parallelized droplet generating apparatus of claim 13, wherein the nozzle body is formed to have a width that progressively decreases toward an end.

15. The parallelized droplet generating apparatus of claim 13, wherein the second inlet includes:
a second-first inlet configured to introduce a first dispersed-phase fluid; and
a second-second inlet configured to introduce a second dispersed-phase fluid,
wherein the second splitter is provided as a pair of second splitters and connected to each of the second-first inlet and the second-second inlet.

16. The parallelized droplet generating apparatus of claim 15, wherein the spraying channel includes:
a first spraying channel configured to be connected to the second splitting channel provided in any one of the pair of second splitters and guide a flow of the first dispersed-phase fluid; and
a second spraying channel configured to be connected to the second splitting channel provided in the other of the pair of second splitters and guide a flow of the second dispersed-phase fluid.

17. The parallelized droplet generating apparatus of claim 16, wherein the first spraying channel and the second spraying channel induce the first dispersed-phase fluid and the second dispersed-phase fluid to be sprayed symmetrically toward the inside of the first droplet generating channel.

18. The parallelized droplet generating apparatus of claim 16, wherein the first spraying channel and the second spraying channel induce the first dispersed-phase fluid and the second dispersed-phase fluid to be sprayed concentrically toward the inside of the first droplet generating channel.

19. The parallelized droplet generating apparatus of claim 18, wherein the first spraying channel includes:
a plurality of extension channels split from the second splitting channels; and
a combining channel configured to be connected to the extension channels and combine the first dispersed-phase fluid flowing along the extension channels,
wherein the second spraying channel communicates with the combining channel and is disposed so that a central axis is positioned coaxially with a central axis of the combining channel.
